(19) United States
(12) Patent Application Publication
(10) Pub. No.: US 2011/0253029 A1
(43) Pub. Date: Oct. 20, 2011

(54) Architectural signs with interlocking solid color tactile components and method of production

(76) Inventor: Reginald K. Hagberg, Oswego, IL (US)

(21) Appl. No.: 12/928,086

(22) Filed: Dec. 3, 2010

Related U.S. Application Data
(60) Provisional application No. 61/283,544, filed on Dec. 4, 2009.

(51) Int. Cl. G01D 13/22

(52) U.S. Cl. 116/205

(57) ABSTRACT

An architectural sign useful to the visually impaired, with tactile components that are resistant to daily wear, cleaning, and vandalisms, and a method of producing such a sign with interlocking solid color components is disclosed. The sign comprised of a planar sign plate or base routed therethrough forming one or more sockets to receive one or more tactile text plugs and one or more Braille plugs. These plugs when inserted, pressed and friction fit through the back of the base until flush therewith, protrude at least 1/32nd inch above the front surface of said sign base. The plugs being fabricated from solid color materials that contrast with the base by at least 70% without painting. The Braille plug provides all the Braille pins for the sign on an integrated base.

### CROSS-REFERENCE TO RELATED APPLICATIONS

This application claims the benefit of provisional patent application Ser. No. 61/283,544, filed 2009 Dec. 4 by the present inventor.

### FEDERALLY SPONSORED RESEARCH

Not Applicable.

### REFERENCE TO A MICROFICHE APPENDIX

Not Applicable.

### SEQUENCE LISTING

Not Applicable.

### DESCRIPTION

1. Field of the Invention

This invention relates in general to architectural signage, particularly to signage with interlocking solid color sign plate, Braille, and tactile components, useful to the visually impaired, and to a method of producing such signage.

2. Background of the Invention

The Americans with Disabilities Act Accessibility Guidelines (ADAAG) of January 1992 requires architectural signage in public places contain tactile text (i.e. letters, numerals, symbols) with or without pictograms raised at least 0.8 mm (0.0325 inches) and Braille characters raised 0.6 to 0.9 mm (0.025 to 0.037 inches) off the surface of the sign with at least a 70% contrast in color between the raised feature (e.g. letters, numerals, symbols or pictograms) and the supporting surface of the sign.

These tactile signs have been fabricated from laminated, poured or solid sheet plastics and metals such as aluminum, brass, copper, magnesium, stainless steel, zinc or any such suitable material known to those skilled in the art.

Plastic signs with tactile text (i.e. letters, numerals, symbols) with or without pictograms, and Braille characters may be fabricated by any technique known to those skilled in the art, such as casting, engraving, etching, injection molding, or routing. Many of these techniques do not provide a crisp well defined and easily palpable edge on the tactile text or Braille. Adhesively attaching the tactile features with good edges to the front supporting surface of the sign may overcome this problem, while making them more susceptible to wear and vandalism. Routing from a single piece can provide a good edge at an increased cost of time and money. For improved tactile experience and durability of plastic signs, the Braille characters are often pre drilled in the front supporting surface of the sign, then plastic or metal ball bearings or domed pins are individually inserted or press fit therein. However, this is a time and labor intensive technique.

Metal signs with tactile text (i.e. letters, numerals, symbols) with or without pictograms, and Braille characters may be fabricated by any technique known to those skilled in the art, such as casting, die stamping, engraving, etching, or routing (CNC) having all the palpability problems and solutions noted for plastic. Like with plastic signs the Braille characters may be fabricated by individually inserting or press fitting ball bearings or domed pins in pre drilled holes to improve palpability. Again, this is a time and labor intensive technique

When ADAAG compliant architectural signs are fabricated out of a single piece of material the requirement for a 70% color contrast between sign plate and the raised tactile components must be achieved by painting or by mechanically or adhesively attaching the contrasting tactile features to the front supporting surface of the sign.

It is known to those skilled in the art that paint and mechanically or adhesively attached tactile front surface components can be degraded or knocked off, by daily wear, maintenance and vandalism i.e. chipped, peeled, picked, scraped off or scratched. It is also known to those skilled in the art that plastic or metal ball bearing and domed pin Braille provides a superior and more ADAAG compliant dot than other techniques, such as casting, die stamping, engraving, etching or injection molding. However this improved Braille comes at a cost. Every ball bearing Braille dot must be individually inserted to a precise depth in a precision hole, an extremely labor intensive fabrication technique requiring expensive special equipment. The domed pins do not have the precision hole depth or special inserting equipment problems the ball bearings do, because their holes may be thru holes, but they still have to be installed one at a time and if the pins are longer than the sign plate is thick, the extra part of the pins protruding out the back of the sign plate must be removed, requiring extra time and labor.

Absent from the art is an architectural sign with: (1) interlocking solid color, sign plate and raised tactile text components that do not require paint to meet ADAAG contrast requirements, thus making this sign less costly, less susceptible to vandalism or wear from daily use or cleaning, (2) a single multi dot, multi cell Braille component describing the above tactile text component (and possibly attached to same), that is installed in and thru the sign plate as a single interlocking unit as opposed to ball bearings and domed pins that must be installed by the time, labor intensive, costly dot by dot method, and a method of producing such a sign.

### OBJECTS AND ADVANTAGES

Accordingly, besides the objects and advantages of the invention described in my above patent, several new and unexpected objects and advantages of my present invention are:
(a) to provide a sign with a solid color sign plate, that resists wear and vandalisms;
(b) to provide a sign with solid color sign plate interlocking components, that resists wear and vandalisms;
(c) to provide a sign where components and sign plate contrast by 70% without paint;
(d) to provide a sign with solid color sign plate and components that cannot be damaged by cleaning;
(e) to provide a sign with crisp palpable edges on the tactile feature;
(f) to provide a sign with a single Braille component that reduces part count;
(g) to provide a sign with a single Braille component that reduces labor cost;
(h) to provide a sign with multicolor components that may be completely injection molded in one process;

Further objects and advantages of my invention will become apparent from a consideration of the drawings and ensuing description.

### BRIEF SUMMARY OF THE INVENTION

The invention, an improved, wear and vandal resistant architectural sign with interlocking solid color sign plate, tactile components and Braille plug, that are fabricated by CNC or laser or water jet or are injection molded and are useful to the visually impaired, and a method of producing any quantity of such a sign economically.

As used in this application:

“ABA” refers to Architectural Barriers Act of 1968, the ADA for federal facilities.

“ADA” refers to the Americans with Disabilities Act, 1991.

“ADAAG” refers to the Americans with Disabilities Act Accessibility Guidelines (1991, as amended through 2002 to 2004) includes both the ABA and ADA.

“ADAAG 703.2.1” “Depth of Raised Letters”: Raised characters shall be 1/32 inch [0.031251 (0.8 mm) minimum above their background. [New] Old ADAAG 4.30.4: Letters and numerals shall be raised 1/32 in (0.8 mm) Note: This also works for Braille per 703.3.1 height is between 0.025 and 0.037 inches or 0.6 and 0.9 mm.

“ADAAG Appendix to Part 1192 Color Contrast and Finish”: The characters and background of signs should be eggshell, matte, or other non-glare finish. An eggshell finish (11 to 19 degree gloss on 60 degree glossimeter) is recommended. Characters and symbols should contrast with their background—either light characters on a dark background or dark characters on a light background. Research indicates that signs are more legible for persons with low vision when characters contrast with their background by at least 70 percent. (Advisory Guidance Not Mandatory) [New] Old ADAAG Appendix 4.32:”

“alphanumeric character” refers to a symbol as used in a writing system, as a letter of the alphabet, a number or a symbol.

“Braille” refers to the system of raised dots that can be read with the fingers by people who are blind or whose eyesight is not sufficient for reading printed material. Developed by the French student Louis Braille in 1821 at the age of 12, as an improvement to Charles Barbiers “night writing” a tactile means for Napoleon's army to communicate in pitch darkness. Prior to this invention published in 1829, Braille (blinded at the age of 3) and his fellow blind students were taught with a system using embossed letters in wood (tactile characters) developed by the blind Alexandrine philosopher, Didymus (313-398 A.D.). [Ref Lascartos and Marketos, 1994], (from “The sensory hand: neural mechanisms of somatic sensation” by Vernon B. Mountcastle, page 472)

“Braille plug” refers to the sign component 48 that provides all the Braille pins 49 on an integrated base, repeating the same information conveyed by the alphanumeric tactile text plug 40 above on the sign. The Braille plug 48 and the tactile text plug 40 are both made of the same thickness material so when mated thru the back of the sign 50 and flush therewith, they protrude at least 1/32nd inch above the front surface 60 of the sign plate 15.

“Braille plug advantage” refers to the reduced labor from reduced parts count realized with this invention, e.g. in FIG. 1 for example, inserting 1 Braille plug versus prior arts inserting 7 ball bearings or domed pins is 1/7th the work. The longer the tactile signs message is, the greater the “Braille plug advantage” e.g. a “womens restroom” sign with Grade 2 Braille requires 34 ball bearings or domed pins to be installed versus 1 Braille plug, yielding a 34 to 1 reduction in assembly work per sign, reducing required assembly per sign by 97% over prior art.

“CNC” refers to a computer numerical controlled machine tools that are operated by abstractly programmed commands encoded on a storage medium, as opposed to manually controlled via handwheels or levers, or mechanically automated via cams alone.

“counter plug(s)” refers to one or more plugs for counter or “counter space”, a term from typography for the negative [or empty] space inside certain alphanumeric characters and symbols, where the background shows thru, e.g. A, B, D, 0, P, Q, R, a, b, d, e, g, o, p, q, 0, 4, 6, 8, 9, @, &, # and $. Counter plugs are made from the same color and thickness material as the sign plate, i.e. the background.

“Interlocking” refers to the press or friction fit of mating parts in this inventions, specifically to the mating of the counters 32 and 34 into the counter sockets 44 and 46 thru the back of the tactile text plug 40, the mating of said tactile text plug 40 and Braille plug 48 into the tactile text socket 54 and Braille socket 56 thru the back surface 50 of the sign plate 15, and the mating of the face plate 70 with sign plug 80. Other forms of interlocking know to those skilled in the art may also be used, such as thermal welding, ultra-sonic welding, solvent welding or adhesive welding. [Mate:=i.e. joining or connecting mechanically; and interlocking:=(of two or more things) engage with each other by overlapping or by the fitting together of projections and recesses.

“Internal chamfer” refers to a beveled edge connecting the back surface of the tactile text plug 40 and the internal surface of the counter sockets 45, 47 to facilitate the mating of the counters 32, 34 therein the tactile text plug 40 or to a beveled edge connecting the back surface 50 of sign plate 15 and the internal surface of the tactile text socket 54 to facilitate the mating of the tactile text plug 40 therein the tactile text socket 54. Same for the Braille socket 56. (Not show in drawings.)

“Message plug” 80 refers to the combining of a tactile text plug 82 portion and a Braille plug 84 portion into a single component with a common integrated base, reducing the signs part count to two components; the message plug 80 and the face plate 70.

“Pictogram or pictograph” refers to a symbol that conveys its meaning through its pictorial resemblance to a physical object. (Not shown in drawings.)

“Plug” refers to a component that fits in or thru a socket in another component;

“Pressure sensitive adhesive (PSA) backing” refers to one method of attaching this invention on a flat surface in the required location. Sometimes referred to as “peel and stick”, this PSA is already attached to the back surface of the invention, the user simply peels off a protective material exposing the PSA and presses the invention in place. Alternative fastening techniques, such as welded studs or mounting holes may also be used. (None are shown in the drawings.)

“sign plate” refers to the solid color main component or base of the sign that is or appears to be the background of the sign and receives one or more solid color plugs (tactile text, pictograms and Braille) thru sockets in its planar rear surface until interlocked and held flush with the rear surface, such that the plugs protrude at least 1/32nd inch above the sign plate front surface. A “sign plate” may also refer to entire panels that receive and support many solid color plugs to identify many adjacent control buttons and panel features, such as emergency phone boxes. Sign plates may be decorated or printed on with UV curable ink or etched prior to routing sockets, eliminating alignment problems of doing a background after routing.

“socket” refers to the hole or hollow therethrough a component into which another component fits.

“solid color” refers to the material having the same color thru out its mass.

“Tactile” refers to an object that can be perceived using the sense of touch. In this patent application tactile objects include all raised sign information, tactile text (i.e. letters, numerals, symbols) and/or pictograms useful to the visually impaired who don't read Braille and have had some visual experience, i.e. have been sighted prior to a visual impairment.

“tactile text plug” refers to the solid color, sign component that provides tactile or raised alphanumeric character(s) or pictographic information on the sign. This plug is at least 1/32nd inch thicker than the sign plate so that when friction mated thru the tactile text socket in the sign plates back surface and flush therewith, this plug protrudes the same 1/32nd inch above the front surface of the sign plate. This tactile text plugs solid color contrasts with the background solid color sign plate by at least 70 percent.

### BRIEF DESCRIPTION OF THE DRAWINGS

It to be understood that the components shown in the following figures are not necessarily to scale, with emphasis instead being placed upon illustrating the principles of the invention.

FIG. 1 is the Fully Assembled Front Perspective View of one embodiment of the invention, an architectural sign with interlocking solid color components: a sign plate, a Braille plug, and a tactile text plug, that contrasts with the sign plate by at least 70 percent.

FIG. 2 is the Exploded Rear Perspective View of the same embodiment of the invention shown in FIG. 1.

FIG. 3 is a cross sectional view of the counter plugs, taken along the plane 3-3 of FIG. 2.

FIG. 4 is a cross sectional view of the tactile text plug with counter sockets and the Braille plug, taken along the plane 4-4 of FIG. 2.

FIG. 5 is a cross sectional view of the sign plate with tactile text and Braille sockets, taken along the plane 5-5 of FIG. 2.

FIG. 6 is a cross sectional Fully Assembled View of one embodiment of the invention, an architectural sign with interlocking solid color tactile components: the Sign plate (FIG. 5), the two counter plugs (FIG. 3), the Braille plug (part of FIG. 4), all the same color, and the tactile text plug (part of FIG. 4), that contrasts with the sign plate by at least 70 percent, taken along the plane 6-6 of FIG. 1.

FIG. 7 is the Assembled Front Perspective View of a two piece embodiment of the invention, a smaller architectural sign used for elevator car control, with a single piece solid color tactile message plug press fit thru the message socket in the 70 percent contrasting sign face plate. This type of sign may be fabricated as a two color injection molding, yielding a single component two solid color sign.

FIG. 8 is the Exploded Perspective Front View of FIG. 7.

### BRIEF DESCRIPTION OF THE REFERENCE NUMERALS IN DRAWINGS

10—one preferred form: of the present sign according to the invention, assembled from a sign plate 15, a tactile text plug 40, two counter plugs 32 and 34, and a Braille plug 48.

15—sign plate: a solid color planar member having a front surface 60 and a rear surface 50, formed of any rigid or semi-rigid material such as metal or plastic, with one or more cutouts therethrough forming a tactile text socket 54 and a Braille socket 56 to receive through the rear surface 50 and hold protruding through the front surface 60 the sign intelligence, i.e. a tactile text plug 40 with a Braille plug 48 describing same.

32—counter plug: same color, material and thickness as the sign plate 15 and interlocks into back of the tactile text plug socket 44 on tactile text plug shoulder 45.

33—front face of counter plug 32: shows thru front of tactile text plug socket 44.

34—counter plug: same color, material and thickness as the sign plate 15 and interlocks into back of the tactile text plug socket 46 on tactile text plug shoulder 47

35—front face of counter plug 34: shows thru front of tactile text plug socket 46.

40—tactile text plug: one or more planar alphanumeric characters formed of any rigid or semi-rigid material such as metal or plastic, said material must be, by ADAAG 703.2.1, a minimum of 1/32 inch (0.8 mm) thicker than the sign plate 15 and contrast with the same sign plate 15 by at least 70 percent by ADAAG Appendix to Part 1192 IV and A4.30.5 Finish and Contrast. Said tactile text plug 40 inserts and press fit mates with and or interlocks into the cutout said tactile text socket 54 through the rear surface 50 of the sign plate 15 and protrudes through the front surface 60 of same sign plate 15 at least the 1/32 (0.03125) inch, required for tactile graphics by ADAAG 703.2.1.

41—tactile text plug shoulder: positions the tactile text plug 40 in the sign plate 15 when the tactile text plug 40 is press fit through the rear surface 50 into the tactile text socket 54 and stopped against the tactile text socket shoulder 52.

42—tactile face of tactile text plug 40: protrudes 1/32 inch from interlocking sign plate front surface 60 per ADAAG 703.2.1.

44—first counter socket: a cutout in tactile text plug 40 with a window therethrough the tactile text plug 40 to friction mate with and contain the counter 32 thereby exposing said counter face 33 to an observer of the sign 10 from the front side 60. This socket 44 may have an internal chamfer (Not shown)

45—counter socket shoulder: positions counter 32 in tactile text plug 40 so the counter 32 is flush with the rear surface 50 of the sign plate 15.

46—second counter socket: a cutout in tactile text plug 40 with a window therethrough the tactile text plug 40 to friction mate with and contain the counter 34 thereby exposing said counter face 35 to an observer of the sign 10 from the front side 60. This socket 46 may have an internal chamfer (Not shown)

47—second counter socket shoulder: positions counter 34 in tactile text plug 40 so the counter 34 is flush with the rear surface 50 of the sign plate 15.

48—Braille plug: one or more Braille cells with zero to six pins 49 in each cell on an integrated base, repeating the tactile text plug 40 information above, formed of any rigid or semi-rigid material such as metal or plastic, said material must be (ADAAG 703.2.1) a minimum of 1/32 inch (0.8 mm) thicker than the sign plate 15 like the tactile text plug 40 and press fit in the Braille socket 56 flush with the planar rear surface 50 of the sign plate 15. Use clear material to fabricate this Braille plug 48 that may be used on any color sign plate 15.

49—Braille pins: part of Braille plug 48, which are made of the same material as sign plate 15, but 0.30 inches thicker to protrude Braille pins 49 therethrough when press fit in the Braille socket 56 and Braille pin sockets 58 of the sign plate 15 back 50 per ADAAG 703.2.1.

50—planar rear surface: of sign plate 15 may, after sign 10 is assembled, receive a pressure sensitive adhesive (PSA), one or more welded studs or any other attachment mechanism well know in the art for mounting this invention, an architectural sign with interlocking solid color tactile text and Braille, where it may be required.

52—tactile text socket shoulder: positions tactile text plug 40 in character socket 54 so the press fit tactile text plug 40 mates flush with the rear surface 50 of the sign plate 15.

54—tactile text socket: a cutout therthru sign plate 15 of identical shape and slightly larger than the tactile text plug 40 to receive and press fit same plug flush with the back 50 of the sign plate 15.

56—Braille socket: a cutout therthru sign plate 15 which press fit mates with the integrated base portion of the Braille plug 48 and holds same flush with the rear surface 50 of the sign plate 15.

58—Braille pin socket: a cutout therthru sign plate 15 that receives the Braille plug pins 49 and passes same therethrough to protrude 0.030″ above the sign plate 15 face 60.

60—planar front surface: of sign plate 15. This front surface 60 of the solid color sign plate 15 may be printed on with a UV curable ink or etched prior to routing the sockets 54 and 58.

70—face plate and message socket: sign 110 solid color front surface, a planar member formed of any rigid or semi-rigid material such as metal or plastic, with one or more cutouts therethrough forming a tactile text socket 72 and Braille pin sockets 74 to be press fit down onto the message plug 80. After this face plate 70 is pressed onto the message plug 80, the message plug tactile text 82 and Braille 84 must protrude above the face plate 70, at least the 1/32 (0.03125) inch, required by ADAAG 703.2.1 and the face plate 70 should contrast with the message plug 80 by 70 percent (ADAAG Appendix to Part 1192). The face plate 70 may be printed on with a UV curable ink or etched prior to routing the tactile text socket 72 and the Braille pin sockets 74.

72—tactile text socket: is a face plate 70 cutout that press fit mates with and interlocks the tactile text plug 82 portion of the message plug 80.

74—Braille pin sockets: are the a face plate 70 cutouts that mate with and interlock the Braille pins 84 portion of the message plug 80.

80—Message plug is the combining of a tactile text portion 82 and a Braille pins portion 84 into a single component with a common integrated base, reducing the signs part count by one component. Note message plugs 80 may also be used thru the cutouts in larger multiple button control panels so that the tactile text portion 82 and the Braille portion 84 extend thru the panel by at least 1/32 inch (ADAAG 703.2.1).

82—tactile text: portion of message plug 80.

84—Braille pins: portion of message plug 80.

110—another preferred embodiment: of the present sign according to the invention, assembled from a face plate 70, a message plug 80 and possibly one or two counters (not shown).

### DETAILED DESCRIPTION OF A PREFERRED EMBODIMENT

In the following discussion of the drawings it is noted that while the descriptions are cast primarily in general terms of architectural signage, particularly to signage with interlocking solid color sign plate, Braille, and tactile components, fabricated by CNC, laser, water jet or injection molding and useful to the visually impaired, the invention may conform to and be used in conjunction with any number of different low or no visibility signs well known in the art, that are useful to the visually unimpaired in emergency situations.

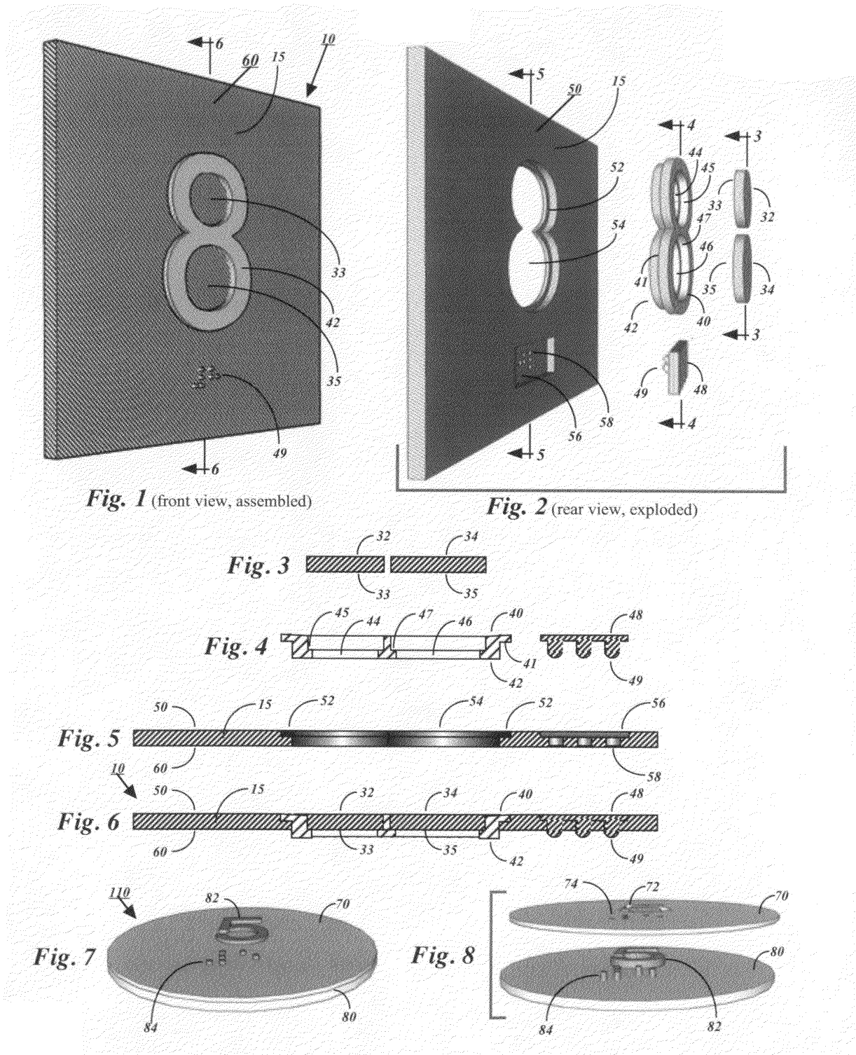

FIG. 1 illustrates in a front perspective view of the fully assembled preferred embodiment of the invention, an architectural sign 10 with interlocking solid color components: a sign plate 15, a Braille plug 48, and a tactile text plug 40, that contrasts with the sign plate 15 by at least 70 percent per ADAAG 703, “ADAAG Appendix to Part 1192 Color Contrast and Finish”. This embodiment is an elevator station jam plate that could be attached with a PSA (not shown), welded studs (not shown) or any other means know to the art.

FIG. 2 is the Exploded Rear Perspective View of the same embodiment of the invention shown in FIG. 1, illustrating the assembly order of the sign 10. First the counter plugs 32 34 which are the same solid color material as the sign plate 15, are press fit interlocked into the back of the counter sockets 44 46 of the tactile text plug 40 until stopped by the counter socket shoulders 45 47 and flush with the back surface (shown but not labeled) of the tactile text plug 40. Next the tactile text plug 40 with both counter plugs 32 34 installed, is press fit interlocked thru the back surface 50 of the sign plate 15 into tactile text socket 54 until the tactile text plugs shoulder 41 rests on the tactile text socket shoulder 52 and the tactile text plugs 40 back surface is flush with sign plates 15 back surface 50 and the tactile text plug 40 protrudes 1/32 inch out from the sign plate 15 front surface 60. Next the Braille pins 49 are inserted thru the sign plates 15 back 50 into the Braille pin socket 58 until the Braille plug 48 press fit interlocks into the Braille socket 56 and the Braille pins protrude 1/32 inch out from the front surface 60 of the sign plate 15, resulting in a fully assembled sign 10. Since all components 32 34 40 48 15 are fully flush with the back side 50 PSA (not shown) is a preferred method of mounting this sign 10 to an elevator jam, however other techniques known to the art may also be employed. Note that press fit interlocking assembly may be facilitated by the internal chamfering of all sockets (not shown).

FIG. 3 is the cross sectional view of the counter plugs 32 34, taken along the plane 3-3 of FIG. 2.

FIG. 4 is the cross sectional view of the tactile text plug 40 with a first counter socket 44, a second counter socket 46, counter socket shoulders 45 47, a Braille plug 48 with Braille pins 49, taken along the plane 4-4 of FIG. 2.

FIG. 5 is a cross sectional view of the sign plate 15 showing the tactile text socket 54, the tactile text socket shoulder 52, the Braille socket 56, the Braille pin sockets 58, the planar rear surface 50 and the planar front surface 60 taken along the plane 5-5 of FIG. 2.

FIG. 6 is the cross sectional view taken along the plane 6-6 of FIG. 1, of the fully assembled embodiment of the invention, an architectural sign 10 with interlocking solid color tactile components: the sign plate 15 of FIG. 5, the two counter plugs 32 34 of FIG. 3, the Braille plug 48 part of FIG. 4, are all the same color, and the tactile text plug 40 part of FIG. 4, contrasts with the sign plate 15 by at least 70 percent. When the sign 10 is fully assembled the counters 32 34 appear to be part of the planar front surface 60 of sign plate 15, giving the illusion of a background, that the tactile text plug 40 is set ON the signs 10 surface 60, when in reality the tactile text plug 40 is firmly interlocked at the back of the sign plate 15, making it impossible to pry or knock off during normal use, cleaning or vandalism, all serious problems for unattended architectural signs. The orientation of FIGS. 3, 4, 5, and 6 illustrates the assembly sequence of the sign 10, i.e. FIG. 3 components descend and interlock into FIG. 4, then that assembly descends and interlocks into FIG. 5, forming the fully assembled sign 10 of FIG. 6. Mounting of this assembly on an elevator jam is normally achieved with PSA, however any mounting technique know in the art may be used. It should be noted here that because the Braille plug 48 is a single component there is a very large assembly advantage to this feature, i.e. one press fit interlock operation as opposed to the many press fit operations common in the art today. FIG. 1 for example, the inserting 1 Braille plug versus prior arts inserting 7 ball bearings or domed pins is 1/7th the work. The longer the tactile signs message is, the greater the “Braille plug advantage” e.g. a “women's restroom” sign with Grade 2 Braille requires 34 ball bearings or domed pins to be installed versus 1 Braille plug, yielding a 34 to 1 reduction in assembly work per sign, reducing required assembly per sign by 97% over prior art.

FIG. 7 is the assembled front perspective view of another preferred embodiment 110 of the invention, a smaller architectural sign used for elevator car control, which combines the tactile text 80 and the Braille pins 84 into a single piece solid color tactile message plug 80, press fit interlocked thru the message sockets 72 74 in the 70 percent contrasting sign face plate 70 of FIG. 8. This type of sign may be fabricated as a two or more color injection molding, yielding a single component two or more solid color architectural sign. This technique yields very cost effective elevator car control signs that would also be resistant to daily wear, cleaning and vandalism.

FIG. 8 is the exploded perspective front view of FIG. 7. It can be seen that counter sunk mounting holes (not shown) could be hidden after mounting by assembling this embodiment on site.

What is claimed is:

1. A sign with interlocking components comprising:
(a) a solid color sign plate with one or more sockets therethrough;
(b) a solid color tactile text plug that contrasts with said sign plate by at least 70 percent and press fits thru the back of said sign plate text socket therein locking;
(c) a Braille plug with a plurality of pins on an integrated base that press fits thru the back of said sign plate Braille socket therein locking;

2. the Braille plug of claim 1 with a plurality of Braille cells on a integrated base.

3. the sign of claim 1 where all sockets are routed on CNC;

4. the tactile text plug of claim 1 where it is routed on CNC;

5. the Braille plug of claim 1 where it is routed on CNC;
